(19) United States
(12) Patent Application Publication
(10) Pub. No.: US 2008/0219676 A1
(43) Pub. Date: Sep. 11, 2008

(54) Transmitting device, receiving device, and optical communication method

(75) Inventors: Seiji Tokura, Kawasaki-shi (JP); Hideaki Hashimoto, Yokohama-shi (JP); Fumio Ozaki, Naka-gun (JP); Hirokazu Sato, Shinagawa-ku (JP); Kaoru Suzuki, Yokohama-shi (JP); Takafumi Sonoura, Fuchu-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/071,590

(22) Filed: Feb. 22, 2008

(30) Foreign Application Priority Data
Mar. 7, 2007 (JP) P2007-057435

(51) Int. Cl. H04B 10/00; H04B 10/04; H04B 10/06

(52) U.S. Cl. 398/140; 398/202; 398/182

(57) ABSTRACT

A receiving device includes a light-receiving unit receiving a light transmitted from a light source, luminance of the light changing corresponding to an information, the light-receiving unit having a plurality of light-receiving elements detecting the light repeatedly at times different from one another, and a decoding unit decoding a light-receiving signal outputted from the light-receiving unit into the information.

### CROSS-REFERENCE TO RELATED APPLICATIONS

This application is based upon and claims the benefit of priority from the prior Japanese Patent Application No. 2007-57435, filed on Mar. 7, 2007; the entire contents of which are incorporated herein by reference.

### BACKGROUND OF THE INVENTION

1. Field of the Invention

The present invention relates to a transmitting device, a receiving device, and an optical communication method performing an optical communication by a luminance change of a light source.

2. Description of the Related Art

An optical communication using an LED illumination is proposed (refer to IEICE technical report WBS2003-38 SAT2003-30 (2003-06)). In this optical communication, a signal is transmitted while changing luminance of light with high frequency which is not sensed by a person so as to keep a function as the illumination. The change of the luminance is converted into the signal by a high-speed receiver such as a phototransistor and a photodiode.

Incidentally, an art of an imaging device is disclosed, in which a row of plural light-receiving elements arranged in a row direction and a column direction is selected and scanned (refer to JP-A No. 2005-191814).

### BRIEF SUMMARY OF THE INVENTION

Here, only information for brightness can be retrieved by a single light-receiving element such as a phototransistor and a photodiode. It is therefore difficult to obtain plural transmission data and to specify a position of a blinking light source. There exists an image sensor (a CMOS image sensor, a CCD image sensor, and so on) as a sensor capable of specifying the position of the blinking light source. However, among them, a sensor sensing in a fast cycle is expensive, and it is difficult to reduce a size as a system.

An object of the present invention is to provide a transmitting device, a receiving device, an optical communication system, and an optical communication method performing an optical communication by using a light-receiving unit.

A receiving device according to an aspect of the present invention includes: a light-receiving unit receiving a light transmitted from a light source, luminance of the light changing corresponding to an information, the light-receiving unit having a plurality of light-receiving elements detecting the light repeatedly at times different from one another; and a decoding unit decoding a light-receiving signal outputted from the light-receiving unit into the information, the light-receiving signal including signal components detected from the light-receiving elements at times different from one another.

A transmitting device according to an aspect of the present invention, which transmits information to a receiving device having plural light-receiving elements detecting a light repeatedly at times different from one another, includes: a first light source; and a first control unit controlling luminance of the first light source with corresponding to the information to be transmitted.

An optical communication method according to an aspect of the present invention includes: controlling luminance of a light source with corresponding to an information; receiving a light from the light source by a light-receiving unit having plural light-receiving elements detecting a light repeatedly at times different from one another; and decoding a light-receiving signal outputted from the light-receiving unit into the information, the light-receiving signal including signal components detected from the light-receiving elements at times different from one another.

### BRIEF DESCRIPTION OF THE DRAWINGS

FIG. 1 is a block diagram showing an optical communication system according to a first embodiment of the present invention.

FIG. 2 is a schematic diagram showing an example of an internal configuration of a light-receiving unit in FIG. 1.

FIG. 3 is a flowchart showing operation procedures at a transmitting device in FIG. 1.

FIG. 4 is a flowchart showing operation procedures at a receiving device in FIG. 1.

FIG. 5 is a timing chart showing a temporal change of a signal transmitted at the optical communication system in FIG. 1.

FIG. 6 is a block diagram showing an optical communication system according to a second embodiment of the present invention.

FIG. 7 is a flowchart showing operation procedures at a transmitting device in FIG. 6.

FIG. 8 is a flowchart showing operation procedures at a receiving device in FIG. 6.

FIG. 9A is a schematic diagram showing a signal at a time of decoding at a signal decoding unit in FIG. 6.

FIG. 9B is a schematic diagram showing the signal at the time of decoding at the signal decoding unit in FIG. 6.

FIG. 9C is a schematic diagram showing the signal at the time of decoding at the signal decoding unit in FIG. 6.

FIG. 9D is a schematic diagram showing the signal at the time of decoding at the signal decoding unit in FIG. 6.

FIG. 9E is a schematic diagram showing the signal at the time of decoding at the signal decoding unit in FIG. 6.

FIG. 9F is a schematic diagram showing the signal at the time of decoding at the signal decoding unit in FIG. 6.

FIG. 10 is a timing chart showing an example of a temporal change of a signal.

FIG. 11 is a timing chart showing an example of a temporal change of a signal.

FIG. 12 is a timing chart showing an example of a temporal change of a signal.

FIG. 13 is a timing chart showing an example of a temporal change of a signal.

### DETAILED DESCRIPTION OF THE INVENTION

Hereinafter, an optical communication system according to the present invention is described in detail based on the drawings. Note that the present invention is not limited by these embodiments.

### First Embodiment

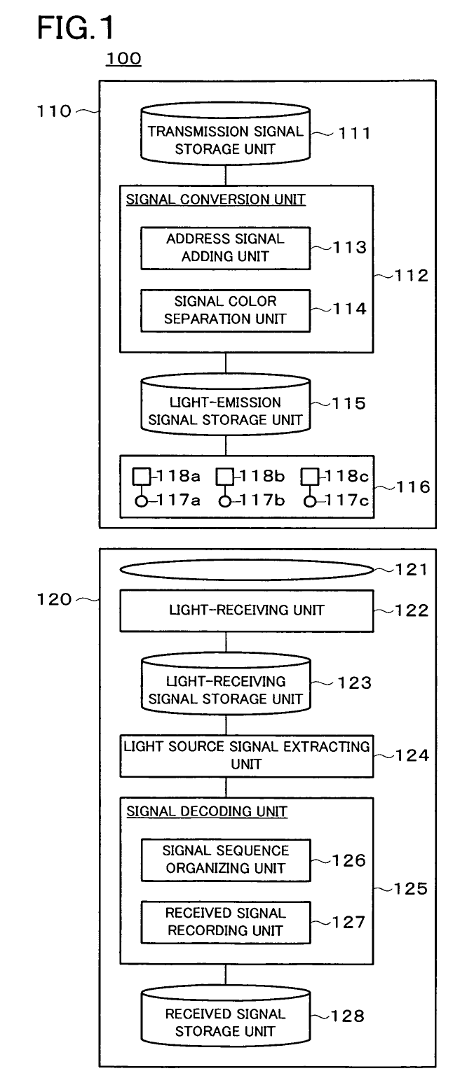

FIG. 1 is a block diagram showing an optical communication system 100 according to a first embodiment of the present invention. The optical communication system 100 is constituted by a transmitting device 110 and a receiving device 120. The transmitting device 110 has a transmission signal storage unit 111, a signal conversion unit 112, a light-emission signal storage unit 115, and a light-emitting unit 116, and a signal is transmitted by a luminance change of a light at the light-emitting unit 116. The receiving device 120 has an optical system 121, a light-receiving unit 122, a light-receiving signal storage unit 123, a light source signal extracting unit 124, a signal decoding unit 125, and a received signal storage unit 128, and the signal from the transmitting device 110 is received.

### (Description of Transmitting Device 110)

Hereinafter, a description of the transmitting device 110 is explained.

The transmission signal storage unit 111 is a storage device, for example, a memory storing a signal (a transmission signal (transmission information)) transmitted from the transmitting device 110. The transmission signal is represented as, for example, digital information such as “100”.

This transmission signal is divided into communication units and transmitted from the transmitting device 110. This communication unit means an information length [bit] transmitted at a time at a later-described one light source 117. For example, when one bit is represented by a contrast of luminance of the light source 117, the communication unit is one bit. In this case, the transmission signal “100” is divided into “1”, “0”, “0”, and they are transmitted sequentially. Here, the communication unit is one bit. As it is described later, it is possible to represent multi-bits by using phases of the contrast of the luminance of the light source 117.

The signal conversion unit 112 converts the transmission signal into a light-emission signal (a luminance control signal controlling the luminance of the light-emitting unit 116), and it has an address signal adding unit 113 and a signal color separation unit 114. Incidentally, details of the address signal adding unit 113 and the signal color separation unit 114 are described later. The light-emission signal storage unit 115 stores the light-emission signal converted at the signal conversion unit 112.

The light-emitting unit 116 has light sources 117a to 117c, and control units 118a to 118c. The light sources 117a to 117c are light-emitting elements such as LED, and emit lights of a first to third colors different from one another (for example, R (red), G (green), B (blue)). The control units 118a to 118c respectively control the luminance of the light sources 117a to 117c based on the light-emission signal stored at the light-emission signal storage unit 115. At this time, the luminance changes with a predetermined interval.

The address signal adding unit 113 adds an address signal by each communication unit of the transmission signal. The address signal is information to identify the communication units with each other (it can be said that a sequence is supplied by each communication unit).

For example, the transmission signal “100” is divided into the communication units, the address signals are added by each communication unit, and thereby, a signal S1 as follows is generated.

(001), (010), (100) . . . signal S1

Here, the address signals of two bits “(00)”, “(01)”, “(10)” are respectively added to the transmission signal “1”, “0”, “0” divided into the communication units. Incidentally, here, “(11)” is not used as an address, but it can be used as the address.

In this example, the transmission signal is three bits. When a transmission signal with a longer information length is transmitted, the address signals “(00)”, “(01)”, “(10)” may be used again.

The signal color separation unit 114 separates the transmission signal and the address signal by each light emission color of the light-emitting unit 116. When display colors of the light-emitting unit 116 are three colors (for example, R, G, B), the signals are separated, for example, by assigning one color (or two colors) to the transmission signal, and the remaining two colors (or one color) to the address signal. Here, one color is assigned to the transmission signal, and the remaining two colors are assigned to the address signal. This assignment of colors means the assignment of the signals to the light sources 117a to 117c respectively.

The above-stated signal S1 is separated into signals S2a to S2c as follows by the signal color separation unit 114.

“0, 0, 1” . . . signal S2a

“0, 1, 0” . . . signal S2b

“1, 0, 0” . . . signal S2c

Each of the signals S2a to S2c mean an address signal 1 (an upper bit of the address signal), an address signal 2 (a lower bit of the address signal), and the transmission signal. The signals S2a to S2c are used for a luminance control of the light sources 117a to 117c, and function as luminance control signals.

The control units 118a to 118c control the luminance of the light sources 117a to 117c based on the signals S2a to S2c, and thereby, the transmission signal to which the address signal is added is transmitted repeatedly from the transmitting device 110.

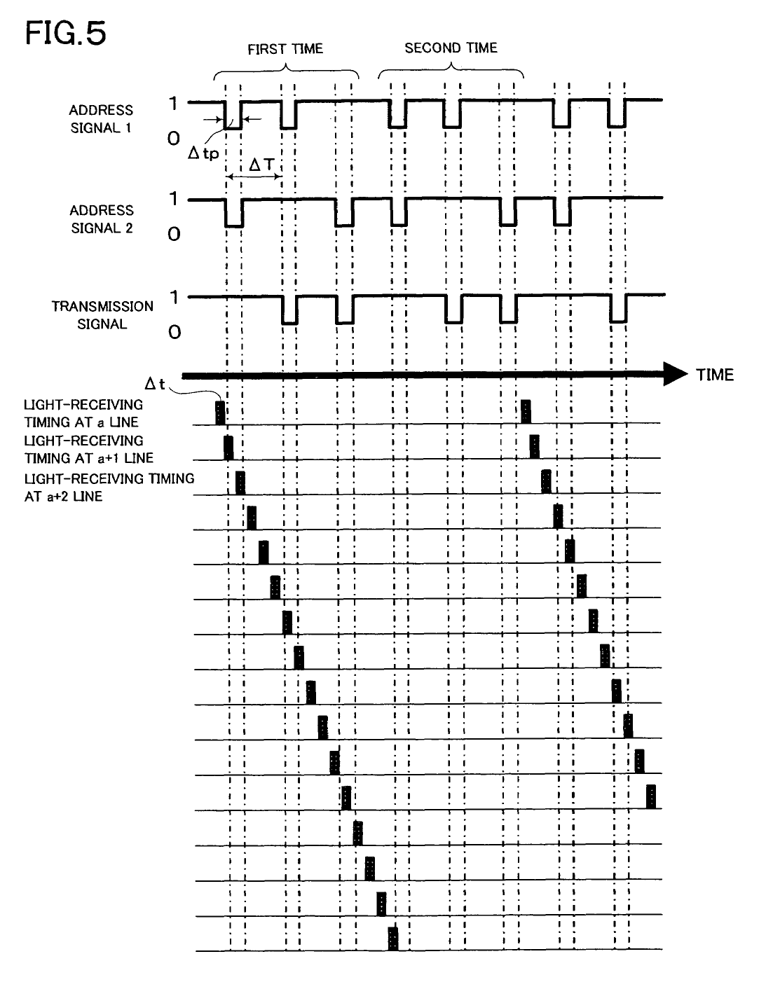

At this time, the light sources 117a to 117c are in bright states as normal states as shown in later-described FIG. 5, and the luminance changes in a pulse state with a predetermined cycle. It becomes possible that the transmitting device 110 is made function as a lighting device by setting the normal states of the light sources 117a to 117c to be the bright states. A time when the luminance of the light sources 117a to 117c changes (a pulse width Δtp) is made short, and thereby, an optical communication becomes possible without being sensed by a person of the luminance change of the light sources 117a to 117c.

As shown in FIG. 5, the luminous change of the light sources 117a to 117c are synchronized (the luminous changes approximately at the same time). As it is described later, it is possible to separate the signals from the respective light sources 117a to 117c by the light source signal extracting unit 124.

### (Description of Receiving Device 120)

Hereinafter, a description of the receiving device 120 is explained.

The optical system 121 forms an image of the light-emitting unit 116 on the light-receiving unit 122. Namely, the lights from the light sources 117a to 117c are condensed on a part of the light-receiving unit 122 (a later-described pixel array 131). As it is described later, it becomes easy to separate the signal from the light-receiving unit 122 into the signals from each of the light sources 117a to 117c as a result of this image-forming (light-condensing).

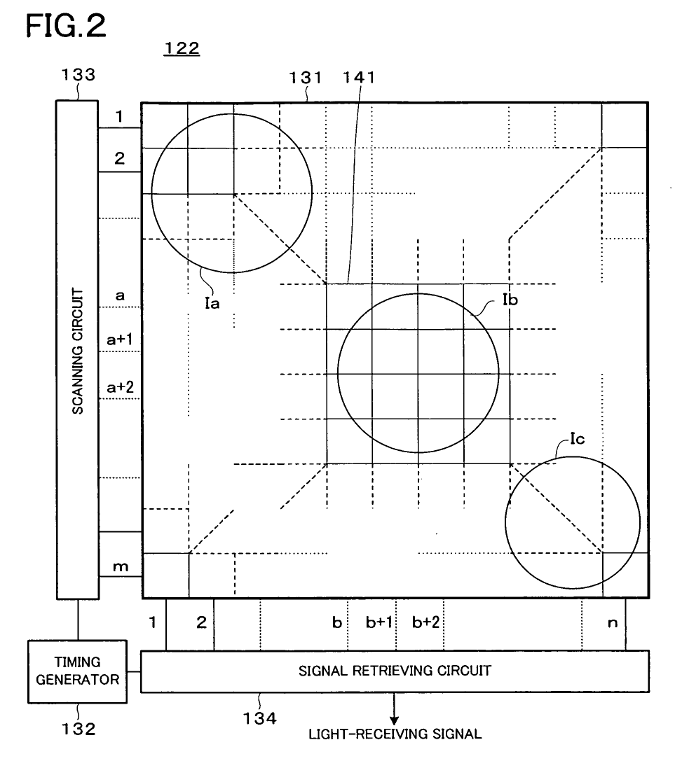

The light-receiving unit 122 is a unit, for example, a CMOS image sensor, receiving the light emitted from the light-emitting unit 116 as an image, and outputting a light-receiving signal. FIG. 2 is a schematic diagram showing an example of an internal configuration of the light-receiving unit 122. Incidentally, the images (condensing regions) Ia to Ic of the light sources 117a to 117c are shown in the drawing.

The light-receiving unit 122 has the pixel array 131, a timing generator 132, a scanning circuit 133, and a signal retrieving circuit 134.

The pixel array 131 has plural pixels (light-receiving elements 141) arranged in a row direction (the number of rows: m) and in a column direction (the number of columns: n). Each of the light-receiving elements 141 can receive lights from the light sources 117a to 117c.

Incidentally, the light-receiving element 141 is enabled to receive any light among R, G, or B, for example, by attaching a color filter of any color of R, G, or B to the light-receiving element 141. It is possible to flatly arrange the light-receiving elements 141 receiving the lights of R, G, B. As a result of this, it becomes possible to identify the light sources 117a to 117c by color.

The timing generator 132 generates a control signal driving the scanning circuit 133 and the signal retrieving circuit 134. The scanning circuit 133 sequentially selects (scans) the row of the pixel array 131 based on the control signal from the timing generator 132. The light-receiving elements 141 with the row number of “1” to the row number of “m” are sequentially selected by the scanning circuit 133, and thereby, signals from all of the light-receiving elements 141 are outputted. The signal retrieving circuit 134 retrieves the signal from the light-receiving element 141 at the row selected by the scanning circuit 133 based on the control signal from the timing generator 132.

As stated above, signal components from the light-receiving elements 141 at respective rows receiving lights at different times from one another are contained in the signal outputted from the light-receiving unit 122. Accordingly, it is possible to grasp a time change of the luminance of the light-emitting unit 116 by the signal from the light-receiving unit 122.

Here, a time when the scanning circuit 133 selects one line is set as a selection time Δt (refer to FIG. 5). Namely, a limit of a time resolution of the signal at the light-receiving unit 122 is the selection time Δt. The selection time Δt is enough smaller than a transmission interval ΔT of the signal (Δt<ΔT). The time required for the scanning circuit 133 to select all of the rows (the time required for reading the signals from a whole surface of the pixel array 131 (1 frame time)) “Tf” is represented by the following expression (1).

Tf=Δt*m expression (1)

As shown in FIG. 2, the images Ia to Ic of the respective light sources 117a to 117c are formed on the light-receiving unit 122. This means that it is possible to separate the signal lights from the respective light sources 117a to 117c by selecting the row and column of the light-receiving unit 122. As it is described later, the light source signal extracting unit 124 separates and extracts the lights (the signal components) from the respective light sources 117a to 117c.

The light-receiving signal storage unit 123 is, for example, a buffer memory, temporary storing a signal (a light-receiving signal S3) outputted from the light-receiving unit 122. This light-receiving signal S3 includes information of light intensity at each light-receiving element 141.

The light source signal extracting unit 124 extracts signal components S4a to S4c corresponding to the lights from the respective light sources 117a to 117c from the light-receiving signal S3. Namely, the signals from the light-receiving elements 141 corresponding to the light sources 117a to 117c are extracted from the light-receiving signal S3. In FIG. 2, the image Ib of the light source 117b is formed on the light-receiving elements 141 within a range of the row numbers of “a” to “(a+3)”, and the column numbers of “b” to “(b+3)”. Accordingly, the light-receiving elements 141 within this range can receive the light from the light source 117b. Namely, the light source signal extracting unit 124 extracts the signal components S4a to S4c from the light-receiving elements 141 corresponding to the images Ia to Ic, from the light-receiving signal S3.

When a positional relationship between the light-emitting unit 116 and the light-receiving unit 122 is constant, a first to third ranges within the pixel array 131 are just to be stored as fixed values.

Here, there is a possibility that the positional relationship between the light-emitting unit 116 and the light-receiving unit 122 changes. It is preferable that the light source signal extracting unit 124 dynamically determines the ranges (the first to third ranges) of the images Ia to Ic within the pixel array 131, to correspond to the change of the positional relationship. For example, it is possible to determine the ranges of the images Ia to Ic as the following descriptions 1) to 3).

### 1) Determination of Whole Area of Images Ia to Ic

As a result of a measurement for a certain period, a whole range of the images Ia to Ic is determined by specifying the light-receiving elements 141 of which signal intensity changes over a predetermined range. This range is specified by a group of the light-receiving elements 141. Incidentally, the ranges of the images Ia to Ic are integrally handled at this stage.

### 2) Division of Ranges of Images Ia to Ic

Respective ranges of the images Ia to Ic are divided from the whole range of the images Ia to Ic. For example, the following methods can be used for the above-stated division.

In general, the groups of the light-receiving elements 141 corresponding to the respective ranges of the images Ia to Ic are separated from one another. Consequently, it is possible to divide the ranges of the images Ia to Ic on a basis that the groups are separated from one another.

Besides, it is also possible to divide the ranges of the images Ia to Ic by a difference of colors. In this case, it is necessary to identify the color of the light received by the light-receiving unit 122 (for example, the light-receiving element 141 is enabled to receive any light of R, G, B).

Incidentally, it is conceivable that the ranges of the images Ia to Ic are limited so as to improve an S/N ratio. For example, centers of gravity of the respective ranges of the images Ia to Ic are asked, and ranges within the predetermined number of pixels from these centers of gravity are set as new ranges of the images Ia to Ic. It becomes possible to eliminate disturbance lights from other than the light sources 117a to 117c owing to the above-stated setting.

3) Determination of Correspondence between Images Ia to Ic and Light Sources 117a to 117c

A correspondence between the images Ia to Ic and the light sources 117a to 117c is unclear in the above-stated descriptions 1) and 2). Consequently, a correspondence between the signal components S4a to S4c and the transmission signal and the address signal is not settled, and the transmission signal cannot be decoded. Accordingly, it is necessary to determine the correspondence between the images Ia to Ic and the light sources 117a to 117c. For example, the determination becomes possible by the difference of colors of the light sources 117a to 117c. Besides, the determination may be made by using the positional relationship between the light sources 117a to 117c and the light-receiving unit 122.

As stated above, the light-receiving elements 141 on which the images Ia to Ic are formed are decided. This means that the lights from the light sources 117a to 117c can be received simultaneously as it is already described.

On the other hand, this means that the light-receiving elements 141 receiving lights from the light sources 117a to 117c are limited. Namely, the received signal from the light-receiving unit 122 remains in a part of the luminance change of the light sources 117a to 117c. For example, when all of the number of rows of the pixel array 131 is set as “m”, and the range of the light-receiving elements 141 on which the image Ib is formed is set as “Δm” rows, then a time zone capable of detecting the luminance change becomes (Δm/m) within every time zone. The reason why the transmission signal is transmitted repeatedly is to enable a reception of the transmission signal within a limited detectable time zone.

The signal decoding unit 125 is to decode the transmission signal based on the three signal components S4a to S4c extracted at the light source signal extracting unit 124, and has a signal sequence organizing unit 126 and a received signal recording unit 127.

The signal sequence organizing unit 126 temporally decomposes the signal component based on the interval ΔT (a transmission speed of information) of the luminance change at the light-emitting unit 116, and converts into the transmission signal (the received signal) and the address signal by each communication unit. Besides, the signal sequence organizing unit 126 aligns the received signals based on the address signals. As a result of this, the received signal is decoded.

Here, sets of (an address 1, an address 2, a signal) are received repeatedly, and therefore, pairs having the same address signal and data information may appear. The received signal (for example, “100”) is determined based on the set of a series of (the address, the signal) (for example, (001), (010), (100)) while ignoring the same pair of the address signal and the data information, as stated above.

The signal sequence organizing unit 126 judges a cut-line of the received signal. The received signal which is different from the former one is decoded with the same address signal, and thereby, the cut-line of the received signal is judged. As it is already described, the transmission signal is transmitted repeatedly, and therefore, there is a possibility that the sets of the same address signals, the received signals may be decoded repeatedly. On the other hand, when information having a long bit length for some extent is transmitted, the same address is reused. In this case, the received signal (transmission information) having the same address signal but different value is to be decoded.

The received signal recording unit 127 stores the decoded received signal to the received signal storage unit 128. The received signal storage unit 128 stores the received information decoded at the signal decoding unit 125.

### (Operation Procedures of Optical Communication System 100)

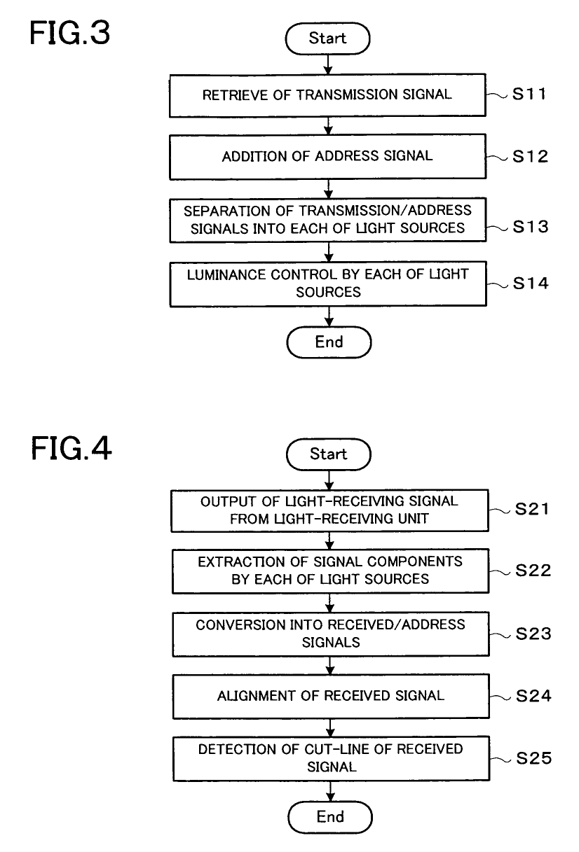

Operation procedures of the optical communication system 100 are described. FIG. 3 and FIG. 4 are flowcharts respectively showing the operation procedures at the transmitting device 110 and the receiving device 120. Besides, FIG. 5 is a timing chart showing a temporal change of a signal transmitted at the optical communication system 100.

### A. Operations of Transmitting Device 110

The operation procedures at the transmitting device 110 are described.

### (1) Retrieve of Transmission Signal (Step S11)

Information to be transmitted is retrieved from the transmission signal storage unit 111, and outputted to the signal conversion unit 112. For example, a transmission signal “001” is outputted.

### (2) Addition of Address Signal to Transmission Signal (Step S12)

The address signal adding unit 113 of the signal conversion unit 112 adds the address signal to the transmission signal. For example, the transmission signal “001” is divided into the communication units, the address signal is added by each communication unit, and thereby, the above-stated signal S1 is generated.

(3) Separation of Transmission Signal, Address Signal into Each of Light Sources 117a to 117c (Step S13)

The signal color separation unit 114 separates the signal S1 into each of the light sources 117a to 117c. As a result of this, the signals S2a to S2c being luminance control signals are generated. The converted luminance control signals are stored at the light-emission signal storage unit 115.

### (4) Luminance Control by Each of Light Sources 117a to 117c (Step S14)

The light sources 117a to 117c of the light-emitting unit 116 emit lights based on the luminance control signals stored at the light-emission signal storage unit 115. As a result of this, the transmission signal and the address signal are transmitted. As shown in FIG. 5, here, it is assumed that the following sets of (the address 1, the address 2, the signal) are transmitted repeatedly.

(0, 0, 1), (0, 1, 0), (1, 0, 0)

Incidentally, when the information having the longer number of bits is transmitted, the address signals “(0, 0)”, “(0, 1)”, “(1, 0)” are used again, and the set of (the address 1, the address 2, the signal) may be transmitted repeatedly.

### B. Operations of Receiving Device 120

Operation procedures at the receiving device 120 are described.

(1) Output of Light-Receiving Signal from Light-Receiving Unit 122 (Step S21)

The light-receiving unit 122 receives lights from the light sources 117a to 117c. The light-receiving signal S3 is outputted from the light-receiving unit 122, and stored at the light-receiving signal storage unit 123.

### (2) Extraction of Signal Components by Each of Light Sources 117a to 117c (Step S22)

The light source signal extracting unit 124 extracts the signal components S4a to S4c, corresponding to the lights from the light sources 117a to 117c, from the light-receiving signal.

(3) Conversion into Received Signal, Address Signal (Step S23)

The signal sequence organizing unit 126 of the signal decoding unit 125 converts the signal components S4a to S4c into the pair of the address signal and the received signal by each communication unit.

### (4) Alignment of Received Signal (Step S24)

The signal sequence organizing unit 126 decodes the received signal by aligning the sequence of the received signal based on the address signals.

### (5) Detection of Cut-Line of Received Signal (Step S25)

When the different received signals are decoded with the same address signal, the signal sequence organizing unit 126 detects the cut-line of the signal. In addition, the cut-line of the transmission signal may be detected based on the number of repeated times “K” of the transmission.

When the cut-line of the transmission signal is detected, the data prior to the cut-line is stored at the received signal storage unit 128 as the data of which organization is completed, by using the received signal recording unit 127.

As stated above, in the present embodiment, the plural light-receiving elements 141 having light-receiving timing lags are used, and thereby, it becomes possible to receive a light blinking signal blinking in a cycle (the interval ΔT) faster than the imaging cycle (the frame time Tf) at the light-receiving unit 122. Besides, it becomes possible to obtain the signals from the plural light sources 117 simultaneously by using the plural light-receiving elements 141.

### Second Embodiment

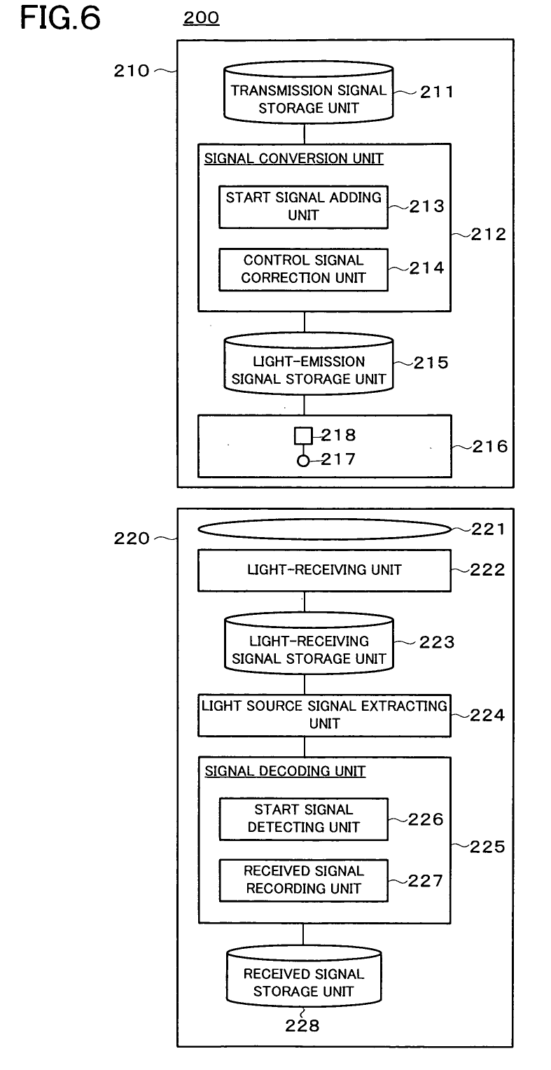

FIG. 6 is a block diagram showing an optical communication system 200 according to a second embodiment of the present invention. The optical communication system 200 is constituted by a transmitting device 210 and a receiving device 220. The transmitting device 210 has a transmission signal storage unit 211, a signal conversion unit 212, a light-emission signal storage unit 215, and a light-emitting unit 216, and a signal is transmitted by a luminance change of a light at the light-emitting unit 216. The receiving device 220 has an optical system 221, a light-receiving unit 222, a light-receiving signal storage unit 223, a light source signal extracting unit 224, a signal decoding unit 225, and a received signal storage unit 228, and a signal from the transmitting device 210 is received.

### (Description of Transmitting Device 210)

Hereinafter, a description of the transmitting device 210 is explained.

The signal conversion unit 212 is to convert a transmission signal into a light-emission signal (a luminance control signal controlling luminance of the light-emitting unit 216), and it has a start signal adding unit 213 and a control signal correction unit 214.

The start signal adding unit 213 adds a start signal at a beginning of the transmission signal. The start signal is a kind of control signal showing start of the transmission signal. The control signal is a signal used to control the transmission of the signal, and it is different from the transmission signal of which object is the transmission of the signal itself. There is a data identification signal in addition to the start signal within the control signals.

The data identification signal is a signal showing that the subsequent signal is not the control signal such as the start signal, but data as it is. It becomes possible to transmit a signal which is the same as the control signal by using the data identification signal.

The control signal correction unit 214 checks whether there is a signal which is the same type as the control signals such as the start signal and the data identification signal or not, in the transmission signal. When there is the same type of signal as the control signal in the transmission signal, the control signal correction unit 214 supplies the data identification signal prior to that portion, and enables the transmission as the transmission signal.

The signal processed by the start signal adding unit 213 and the control signal correction unit 214 is used for a later-described luminance control of a light source 217, and functions as a luminance control signal.

The light-emitting unit 216 has the light source 217 and a control unit 218. Namely, in the present embodiment, the light source 217 of which luminance is controlled is one.

Incidentally, the transmission signal storage unit 211 and the light-emission signal storage unit 215 respectively are not substantially different from the transmission signal storage unit 111 and the light-emission signal storage unit 115 in the first embodiment, and therefore, the detailed description is not given.

(Description of Receiving Device 220)

Hereinafter, a description of the receiving device 220 is described.

The light source signal extracting unit 224 extracts a signal component S4 corresponding to the light from the light source 217 from a light-receiving signal S3. This corresponds that the number of the light source 217 of which luminance is controlled is one. In the other points, there is no substantial difference between the light source signal extracting unit 224 and the light source signal extracting unit 124 in the first embodiment.

The signal decoding unit 225 is to decode the transmission signal based on the signal component S4 extracted at the light source signal extracting unit 224, and it has a start signal detecting unit 226 and a received signal recording unit 227.

The start signal detecting unit 226 estimates a received signal from the signal component S4 based on a ratio “R” (=Δtp/Δt) between a period when the luminance changes (a pulse width Δtp) and a selection time Δt, and an information length “N” of the transmission signal. Further, the start signal detecting unit 226 decodes the received signal by detecting a start signal in the estimated received signal. Incidentally, a description will be stated later.

The received signal recording unit 227 stores the decoded received signal to the received signal storage unit 228.

Incidentally, the optical system 221, the light-receiving unit 222, the light-receiving signal storage unit 223 and the received signal storage unit 228 respectively are not substantially different from the optical system 121, the light-receiving unit 122, the light-receiving signal storage unit 123 and the received signal storage unit 128 in the first embodiment, and therefore, the detailed description is not given.

### (Operation Procedures of Optical Communication System 200)

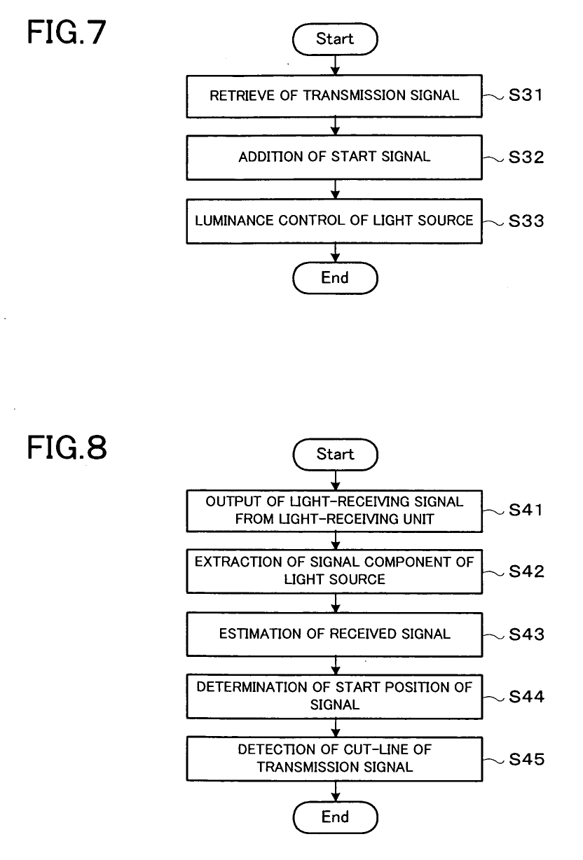

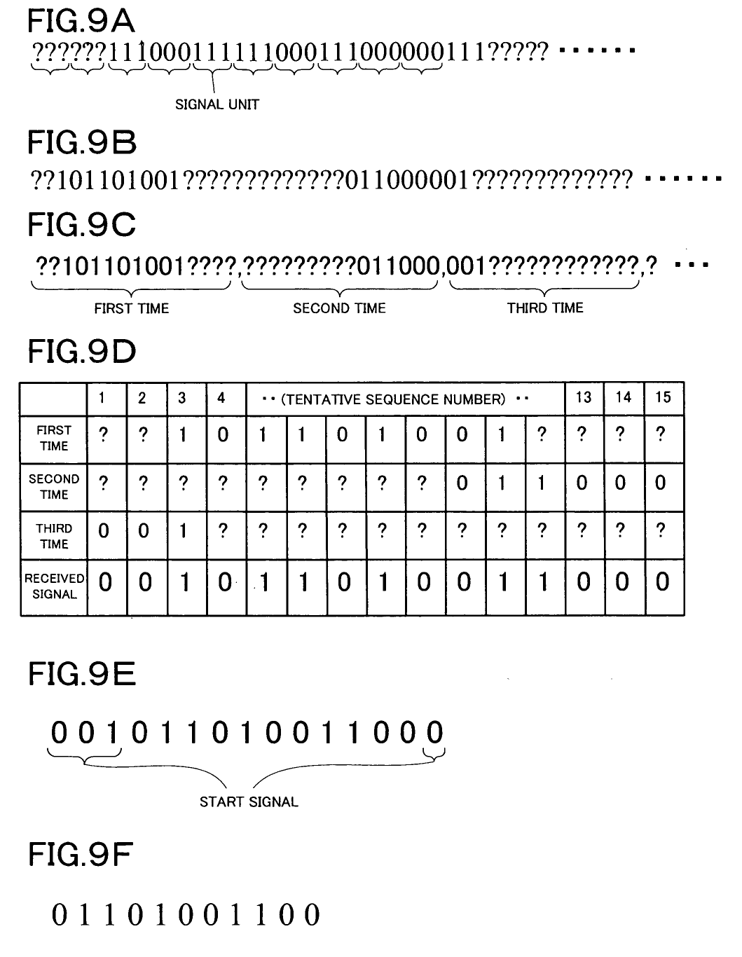

Operation procedures of the optical communication system 200 are described. FIG. 7 and FIG. 8 respectively are flowcharts showing the operation procedures at the transmitting device 210 and the receiving device 220. FIG. 9A to FIG. 9F are schematic diagrams showing signals at the time of decoding at the signal decoding unit 225.

### A. Operations of Transmitting Device 210

### (1) Retrieve of Transmission Signal (Step S31)

Information to be transmitted is retrieved from the transmission signal storage unit 211, and outputted to the signal conversion unit 212. For example, a transmission signal “01101001100” is outputted.

### (2) Addition of Start Signal (Step S32)

The start signal adding unit 213 of the signal conversion unit 212 adds a start signal at a beginning of the transmission signal. Here, a start signal “0001” is added to the signal “01101001100”, and a signal “000101101001100” is generated. This signal functions as a luminance control signal. The luminance control signal is stored at the light-emission signal storage unit 215.

Incidentally, the control signal correction unit 214 checks whether there is the same type of signal as the control signal or not within the transmission signal, and adds a data identification signal if necessary.

### (3) Luminance Control of Light Source 217 (Step S33)

The light-emitting unit 216 emits light based on the luminance control signal stored at the light-emission signal storage unit 215. As a result, for example, the signal “000101101001100” is transmitted.

### B. Operations of Receiving Device 220

Operation Procedures at the receiving device 220 are described.

(1) Output of Light-Receiving Signal from Light-Receiving Unit 222 (Step S41)

The light-receiving unit 222 receives the light from the light source 217. A light-receiving signal is outputted from the light-receiving unit 222, and stored at the light-receiving signal storage unit 223.

### (2) Extraction of Signal Component of Light Source 217 (Step S42)

The light source signal extracting unit 224 extracts the signal component S4 corresponding to the light from the light source 217 from the light-receiving signal. Here, the signal component S4 during a period when the luminance changes (a section of the pulse width Δtp) is extracted. Incidentally, it is possible to extract the period when the luminance changes from the signal component based on a periodicity of change of signal intensity.

FIG. 9A shows an example of the signal component S4. Here, marks “?” in FIG. 9A are unclear values, and they show that the luminance change of the light source 217 is not detected by the light-receiving unit 222. As stated above, there is a limit in a time zone when the light-receiving unit 222 can detect the luminance change of the light source 217.

### (3) Estimation of Received Signal (Step S43)

The start signal detecting unit 226 of the signal decoding unit 225 estimates the received signal based on the signal component S4.

### 1) Estimation of Transmission Signal by Each Communication Unit

The transmission signal is estimated by each communication unit based on the signal component S4. It is assumed that the received signal is shown in FIG. 9A. Here, the transmission signal can be estimated based on the ratio “R” (=Δtp/Δt) between the period when the luminance changes (the pulse width Δtp) and the selection time Δt. Here, the ratio “R” is set to be three. This means that a signal of one communication unit is light-received by the light-receiving elements 141 in three lines.

The estimation result based on the received signal in FIG. 9A is shown in FIG. 9B. A signal sequence in FIG. 9A is divided by every three signals, the transmission signal is estimated by every three signals by majority decision, and thereby, a signal sequence in FIG. 9B is estimated. Incidentally, here, the ratio “R” is set as an integral number for easy to understand. If the ratio “R” is not the integral number, a substantially similar process can be performed by taking an average and so on.

### 2) Division/Superposition of Signal

The signal is divided and superposed based on an information length “N” [bit] of the transmission signal. Here, the information length “N” of the transmission signal is set as “15”. A state in which the signal in FIG. 9B is divided is shown in FIG. 9C. In FIG. 9D, the divided signals are superposed, and the transmission signal is estimated. At this time, a tentative sequence number is supplied by each communication unit. A real sequence number is determined by finding the start signal “0001”.

FIG. 9D shows a superposition state when the signals for three times (15×3=45 bits) are received. An average of the signals of the first time to the third time is calculated while ignoring the unclear values, and thereby, a whole of the received signal is estimated (the received signal in FIG. 9D).

As stated above, the value of the received signal is calculated by using the ratio “R” between the period when the luminance changes (the pulse width Δtp) and the selection time Δt, and the information length “N” of the transmission signal. The received signal is then estimated by superposing the values of the received signal by each sequence number based on the light-receiving signals received repeatedly.

### (4) Determination of Start Position of Signal (Step S44)

The start signal “0001” is detected from the estimated received signal, and deleted. At the same time, the received information is decoded by reading the signal just after the start signal as the first of the signal (FIG. 9E, FIG. 9F).

In this example, the start signal “0001” is dispersed into the tentative sequence numbers 15, 1 to 3. The signal is transmitted repeatedly, and therefore, the dispersion of the start signal as stated above may occur. Namely, the start signal is searched from among the estimated received signal on a basis that the last part and the beginning part of the tentative sequence numbers are connected, and a start position of the signal is determined.

### (5) Detection of Cut-Line of Transmission Signal (Step S45)

The start signal detecting unit 226 detects a cut-line of the transmission signal. For example, the cut-line of the transmission signal can be detected based on the repetition number of times “K” of the transmission. Besides, the decoding results of the signal are monitored constantly, and the cut-line of the transmission signal may be detected based on a change of the decoding results. When the cut-line of the transmission signal is detected, the data prior to the cut-line is stored at the received signal storage unit 228 by using the received signal recording unit 227 as the data of which organization is completed.

### Other Embodiments

Embodiments of the present invention can be expanded/modified without being limited to the above-described embodiments, and such expanded/modified embodiments are also included in the technical scope of the present invention.

### (1) Addition of Trigger Signal

In the first embodiment, the address signal is transmitted together with the transmission signal. A trigger signal may be transmitted instead of the address signal.

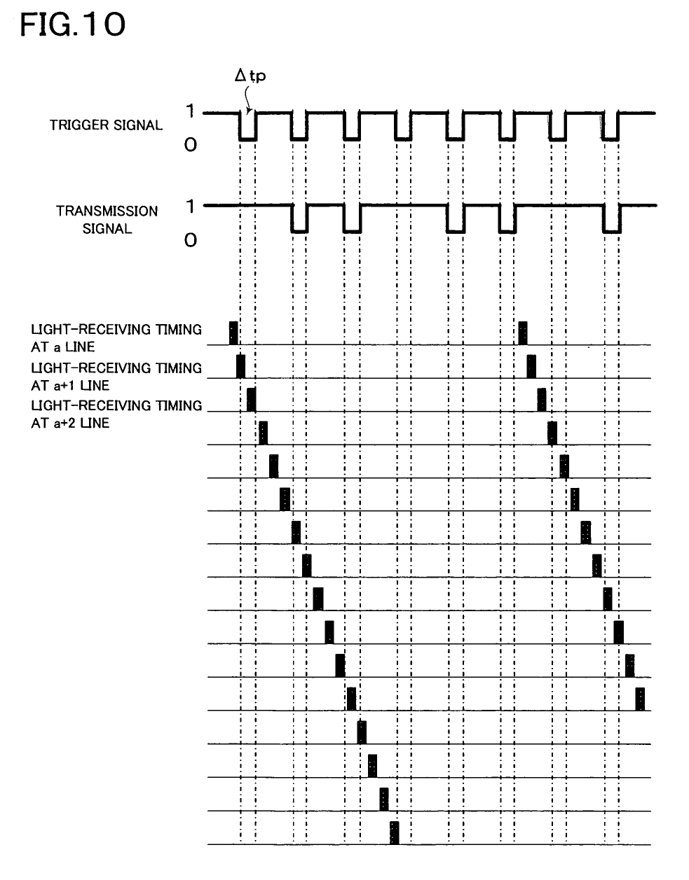

FIG. 10 is a timing chart showing a temporal change of a signal when the trigger signal and the transmission signal are transmitted together. For example, the trigger signal and the transmission signal are synchronized to be transmitted at the light sources 117a, 117b respectively. This trigger signal represents a period (a pulse width Δtp) when the transmission signal is transmitted from the light source 117a (the luminance changes). A reception of the transmission signal becomes easy by detecting luminance of the light source 117b during the period when the trigger signal is “0” (zero).

Incidentally, the address signals 1, 2 shown in the first embodiment can be used as the trigger signal. As shown in FIG. 5, at least either of the address signals 1, 2 becomes “0” (zero) during the transmission period (the pulse width Δtp) of the transmission signal. Namely, a logical AND operation is performed on the address signals 1, 2, and thereby, the trigger signal is generated.

### (2) Parallel Transmission

It is possible to transmit the transmission signal in parallel by using plural light sources 117. For example, the trigger signal, a transmission signal 1, a transmission signal 2 are assigned to each of the light sources 117a to 117c.

### (3) Multi-Bit of Transmission Unit

It is possible to turn the transmission signal into multi-bit.

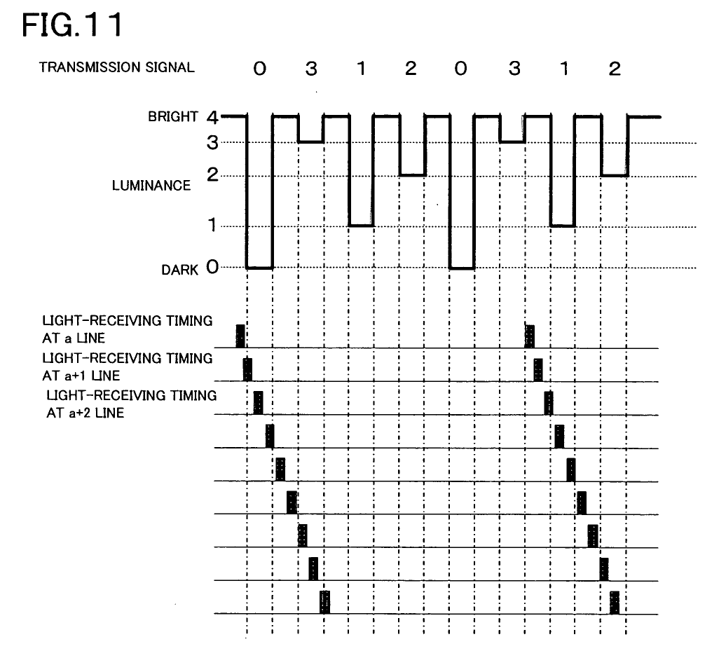

FIG. 11 is a timing chart showing a temporal change of a transmission signal of which transmission unit is turned into multi-bit. As shown in the drawing, the luminance of one light source is changed in multi-stages, and thereby, the transmission unit can be turned into multi-bit.

### (4) Signal Transmission by Difference

It is possible to represent the transmission signal by using a difference from reference luminance. Here, two kinds of differences are conceivable in which a usage of a difference of the luminance among the plural light sources from one another, and a usage of a difference of the luminance which temporally changes at the same light source.

Difference of Luminance from Other Light Sources

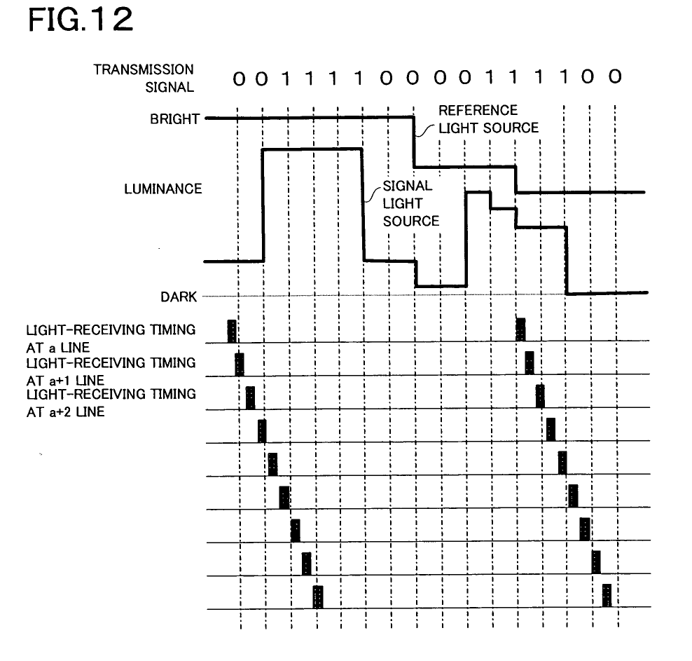

FIG. 12 is a timing chart showing a temporal change of a transmission signal when a difference between luminance of a reference light source (reference luminance) and luminance of a signal light source is used for the transmission signal. Here, brightness of approximately 75% relative to the reference luminance is set as “1”, and brightness of approximately 25% is set as “0” (zero).

### Difference of Luminance at Same Light Source

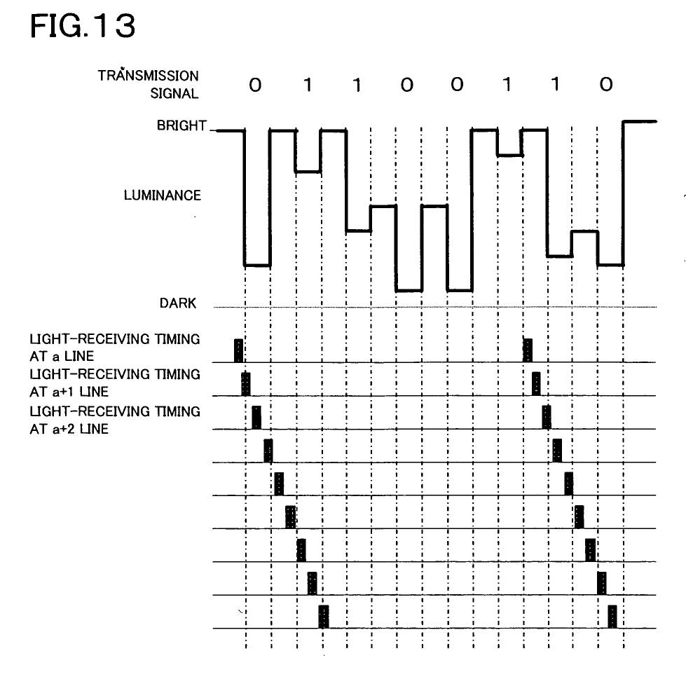

Luminance of the temporally subsequent step is set as reference luminance, and a signal may be transmitted by a difference of a luminance value relative to the reference luminance. FIG. 13 is a timing chart showing a temporal change of a transmission signal when the difference between the luminance of the reference light source (the reference luminance) and the luminance of the signal light source is used for the transmission signal. Here, brightness of approximately 75% relative to the reference luminance is set as “1”, and brightness of approximately 25% is set as “0” (zero).

What is claimed is:

1. A receiving device, comprising:
a light-receiving unit receiving a light transmitted from a light source, luminance of the light changing corresponding to an information, the light-receiving unit having a plurality of light-receiving elements detecting the light repeatedly at times different from one another; and
a decoding unit decoding a light-receiving signal outputted from the light-receiving unit into the information, the light-receiving signal including signal components detected from the light-receiving elements at times different from one another.

2. The receiving device according to claim 1, further comprising:
an optical system condensing the light from the light source on the light-receiving unit; and
a signal extracting unit extracting a signal component from the light-receiving signal, the signal component being generated by at least one of the light-receiving elements included in an area corresponding to the condensed light,
wherein the decoding unit decodes the signal component extracted at the signal extracting unit into the information.

3. The receiving device according to claim 2,
wherein the light-receiving unit receives lights of which luminance changes from a plurality of light sources, and
the signal extracting unit separates and extracts a plurality of signal components corresponding to each of images of the light sources, from the light-receiving signal.

4. The receiving device according to claim 3,
wherein the light-receiving unit further includes a color filter.

5. A transmitting device transmitting information to a receiving device having plural light-receiving elements detecting a light repeatedly at times different from one another, comprising:
a first light source; and
a first control unit controlling luminance of the first light source with corresponding to an information.

6. The transmitting device according to claim 5, further comprising:
a second light source; and
a second control unit controlling luminance of the second light source at a time corresponding to the control of the luminance of the first light source by the first control unit.

7. The transmitting device according to claim 6,
wherein the information is divided into plural communication units, and
the second control unit controls the luminance of the second light source based on at least a part of address information corresponding to each communication unit.

8. The transmitting device according to claim 7,
wherein the second control unit controls the luminance of the second light source based on the part of a address information, and the transmitting device further comprising:
a third light source; and
a third control unit controlling luminance of the third light source based on another part of the address information at a time corresponding to the control of the luminance of the first light source by the first control unit.

9. The transmitting device according to claim 5, further comprising:
a second light source emitting light of reference luminance; and
a conversion unit converting the information into a signal based on the reference luminance,
wherein the first control unit controls the luminance of the first light source based on the signal converted at the conversion unit.

10. The transmitting device according to claim 5, further comprising:
an information adding unit adding transmission start information to the information,
wherein the first control unit controls the luminance of the first light source based on the information to which the transmission start information is added at the information adding unit.

11. An optical communication method, comprising:
controlling luminance of a light source with corresponding to an information;
receiving a light from the light source by a light-receiving unit having plural light-receiving elements detecting a light repeatedly at times different from one another; and
decoding a light-receiving signal outputted from the light-receiving unit into the information, the light-receiving signal including signal components detected from the light-receiving elements at times different from one another.

12. The optical communication method according to claim 11, further comprising:
an optical system condensing the light from the light source on the light-receiving unit; and
a signal extracting unit extracting a signal component from the light-receiving signal, the signal component being generated by at least one of the light-receiving elements included in an area corresponding to the condensed light,
wherein the decoding unit decodes the signal component extracted at the signal extracting unit into the information.

13. The optical communication method according to claim 12,
wherein the light-receiving unit receives lights of which luminance changes from a plurality of light sources, and
the signal extracting unit separates and extracts a plurality of signal components corresponding to each of images of the light sources, from the light-receiving signal.

14. The optical communication method according to claim 13,
wherein the light-receiving unit further includes a color filter.
